(19) United States
(12) Patent Application Publication
(10) Pub. No.: US 2007/0167158 A1
(43) Pub. Date: Jul. 19, 2007

(54) Method and system to enable roaming on demand in wireless communication networks

(75) Inventors: Santosh N. Ajjannavar, Karnataka, IN (US); Rohan Shankar Vaidya, Maharashtra, IN (US)

Correspondence Address: William L. Botjer, PO Box 478, Center Moriches, NY, 11934, US

(73) Assignee: UTSTARCOM INC., Alameda, CA (US)

(21) Appl. No.: 11/332,422

(22) Filed: Jan. 13, 2006

(51) Int. Cl. H04Q 7/20

(52) U.S. Cl. 455/433

(57) ABSTRACT

A method and system for enabling a first communication device to communicate with a second communication device. The first communication device is in a first network. The second communication device is in a second network. The second communication device has network connectivity only in its home network. When a first call for the second communication device is received from the first communication device, roaming on the second communication device is enabled and the location of the second communication device is determined. After determining the location of the second communication device, the first call is routed to the second communication device.

### BACKGROUND

The present invention generally relates to the field of wireless communication. More specifically, it relates to roaming in a wireless communication network.

Wireless communication is transmission of information signals between two communication devices, without a physical connection between them. Examples of a wireless communication network include a wireless Local Area Network (LAN), a wireless mobile communication network, and a wireless Wide Area Network (WAN). Examples of a communication device include a cellular telephone, a cordless telephone, a pager and a laptop.

In a wireless communication network, each communication device is registered with a service provider, which provides connectivity to the registered communication device with other communication devices within the network. This network becomes the home network of the registered communication device. When a communication device moves out of its home network, it loses its connectivity with other communication devices. This is because the communication device has connectivity with other communication devices only within its home network.

Existing methods provide connectivity to a communication device that is out of its home network, with other communication devices through “roaming”. Roaming on a communication device has to be enabled before the communication device moves out of its home network. Roaming in a mobile communication network refers to extending the connectivity service of a communication device to a network other than its home network. To enable roaming on a communication device, a Service Level Agreement (SLA) is required between the service provider for the communication device in its home network and a service provider in the network to which the communication device has moved from its home network. Further, a user may not want to enable roaming unless necessary because additional charges have to be paid for the roaming facility.

In view of the foregoing discussion, there is a need for a method and a system that enable a communication device to have connectivity with other communication device when the communication device is outside its home network. The method and system should not require any processing by a communication device before it moves out of its home network. More specifically, the method and system should not require a communication device to enable roaming before moving out of its home network in order to have connectivity with other communication devices. Further, the method and system should provide on demand roaming on a communication device when the communication device is out of its home network.

### SUMMARY

An objective of the invention is to enable communication between a first communication device and a second communication device. The first communication device is in a first network. The second communication device is in a second network. The second communication device has network connectivity only in its home network. The home network of the second communication device is different from the second network.

Another objective of the invention is to enable communication between a first communication device and a second communication device. The first communication device is in a first network. The second communication device is in a second network. The second communication device has connectivity in its home network. The home network of the second communication device is different from the second network. The communication between the first and the second communication device is enabled through a third network.

Yet another objective of the invention is to provide on demand roaming on a communication device when the communication device is out of its home network.

To achieve the foregoing objectives, the present invention provides a method for enabling a first communication device to communicate with a second communication device. The first communication device is in a first network. The second communication device is in a second network. The second communication device has network connectivity only in its home network. The home network of the second communication device is different from the second network. The method includes receiving a first call from the first communication device for communication with the second communication device, enabling roaming on the second communication device, locating the second communication device and executing the first call.

The present invention also provides a mobile communication network suitable for enabling a first communication device to communicate with a second communication device. The first communication device is in a first network. The second communication device is in a second network. The second communication device has network connectivity only in its home network. The home network of the second communication device is different from the second network. The mobile communication network includes a plurality of mobile switching centers and a plurality of base station subsystems. Each mobile switching center includes a call processing module, a requesting module, a message exchange module and a location-determining module. The requesting module requests a home location register of the second communication device to enable roaming on the second communication device. The location determining module determines the location of the second communication device. Each base station subsystem includes a call processor, a receiving module and a sending module. The receiving module receives an information update message. The sending module sends an update acknowledge message.

### BRIEF DESCRIPTION OF THE DRAWINGS

FIG. 1a illustrates network architecture for call processing, in accordance with an embodiment of the present invention.

FIG. 1b illustrates network architecture for call processing, in accordance with another embodiment of the present invention.

FIG. 2 is a block diagram illustrating a mobile switching center, in accordance with an embodiment of the present invention.

FIG. 3 is a block diagram illustrating a base station subsystem, in accordance with an embodiment of the present invention.

FIG. 4 is a flowchart of a method for call processing, in accordance with an embodiment of the present invention.

FIG. 5 is a flowchart of a method for call processing, in accordance with another embodiment of the present invention.

FIG. 6 illustrates a process for locating a communication device using network architectures as described in FIGS. 1a and 1b.

FIG. 7 illustrates a process for locating a communication device using location based services.

### DESCRIPTION OF VARIOUS EMBODIMENTS

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

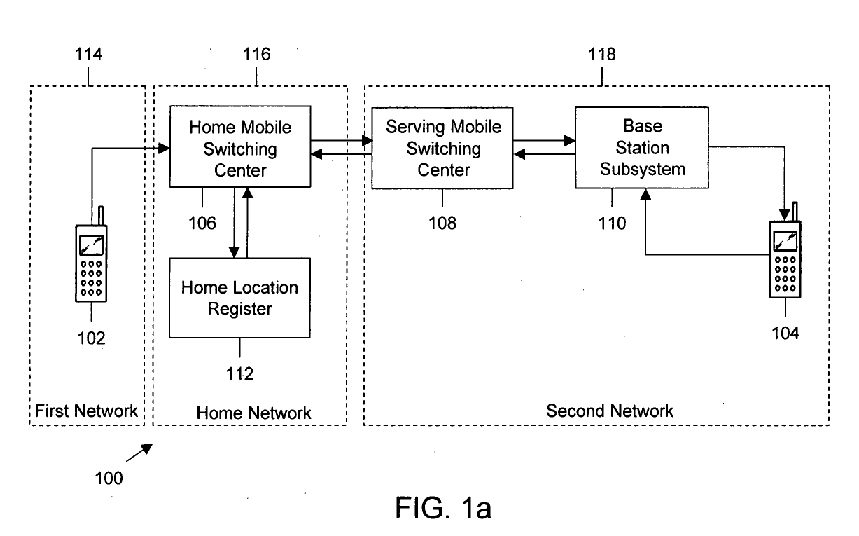

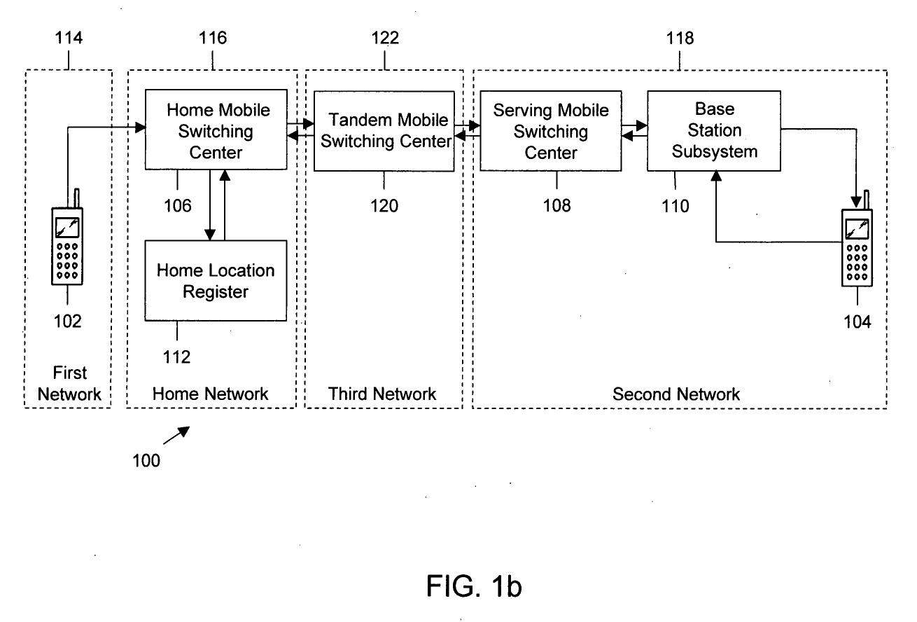

FIG. 1a illustrates a network architecture 100 for call processing, in accordance with an embodiment of the present invention. Network architecture 100 includes a first communication device 102, a second communication device 104, a home mobile switching center 106, a serving mobile switching center 108, a base station subsystem 110, a home location register 112, a first network 114, a home network 116, and a second network 118. First communication device 102 is in first network 114. First network 114 is the home network of first communication device 102. The home network of a communication device is defined as a network that has a network prefix equal to the network prefix of home address of the communication device. Home network 116 is the home network of second communication device 104. In an embodiment of the present invention, first network 114 and home network 116 are the same. Second communication device 104 is in second network 118. Second communication device 104 has connectivity only within home network 116. A service provider of second communication device 104 in home network 116 has a Service Level Agreement (SLA) with a service provider in second network 118.

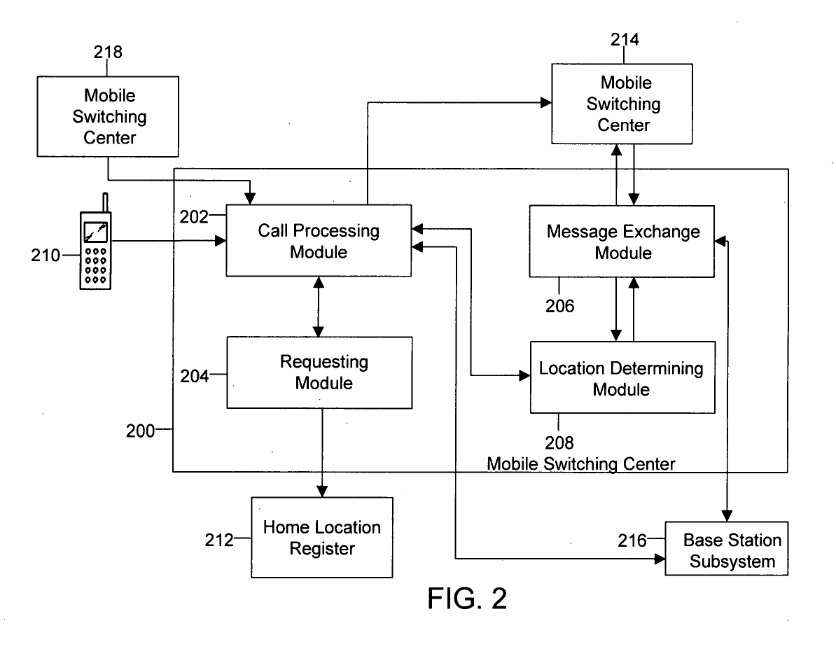

First communication device 102 makes a first call to home mobile switching center 106 for communication with second communication device 104. The first call is made using a feature code and a connection number for second communication device 104. The service provider of first communication device 102 provides the feature code. The service provider of first communication device 102 is in first network 114. Home mobile switching center 106 receives the first call. A mobile switching center is further explained in conjunction with FIG. 2. Home mobile switching center 106 recognizes the first call, based on the feature code. After recognizing the first call, home mobile switching center 106 requests home location register 112, to enable roaming on second communication device 104. In addition, home mobile switching center 106 determines the location of second communication device 104. The location of second communication device 104 is determined by determining the location of serving mobile switching center 108. A mobile switching center that serves a communication device while it is out of its home network, is referred to as a serving mobile switching center of the communication device. Once the location of second communication device 104 is determined, home mobile switching center 106 routes the first call to serving mobile switching center 108. On receiving the first call, serving mobile switching center 108 sends a page request for second communication device 104 to base station subsystem 110. In addition, serving mobile switching center 108 routes the first call to base station subsystem 110. Base station subsystem 110 receives the first call and pages second communication device 104. Paging a communication device includes transmitting a signal via radio from one communication device to another communication device in a defined operating area.

In an embodiment of the present invention, as illustrated in FIG. 1b, network architecture 100 further includes a tandem mobile switching center 120. Tandem mobile switching center 120 is in a third network 122. A service provider in third network 122 has an SLA with the service provider of second communication device 104 in home network 116 and a service provider in second network 118. After determining the location of second communication device 104, home mobile switching center 106 routes the first call to tandem mobile switching center 120, which then routes the first call to serving mobile switching center 108.

FIG. 2 is a block diagram of a mobile switching center 200, in accordance with an embodiment of the present invention. A mobile switching center is a device within a wireless telephony network that performs routing of calls to and from base station subsystems (BSSs), and forwards calls from BSSs to a Public Switched Telephone Network (PSTN), another mobile switching center (MSC), an Internet Service Provider (ISP), or a private network for connection to an appropriate destination. The mobile switching center further provides additional functionalities, such as registration, authentication, location updating, handovers, and call routing to a roaming communication device. Mobile switching center 200 includes a call processing module 202, a requesting module 204, a message exchange module 206, and a location determining module 208. In an embodiment of the present invention, call processing module 202 receives a first call. The first call may be received from a communication device or a mobile switching center. For example, call processing module 202 receives a first call from communication device 210 or mobile switching center 218. In another embodiment of the present invention, call processing module 202 communicates with requesting module 204 to provide information about a first call.

In another embodiment of the present invention, call processing module 202 communicates with location determining module 208 to determine the location of a communication device. In another embodiment of the present invention, call processing module 202 routes a first call to a mobile switching center or a base station subsystem. For example, call processing module 202 routes a first call to mobile switching center 214 or base station subsystem 216. In another embodiment of the present invention, call processing module 202 sends a page request to a base station subsystem. For example, call processing module 202 sends a page request to base station subsystem 216. Requesting module 204 requests a home location register of a communication device to enable roaming on the communication device. Message exchange module 206 exchanges messages with a mobile switching center, which is directly connected to mobile switching center 200. Further, message exchange module 206 exchanges messages with a base station subsystem of mobile switching center 200. These messages are further explained in the later section. For example, message exchange module 206 exchanges messages with mobile switching center 214 and base station subsystem 216. Location determining module 208 determines the location of a communication device. In another embodiment of the present invention, location determining module 208 communicates with message exchange module 206 about the location of a communication device.

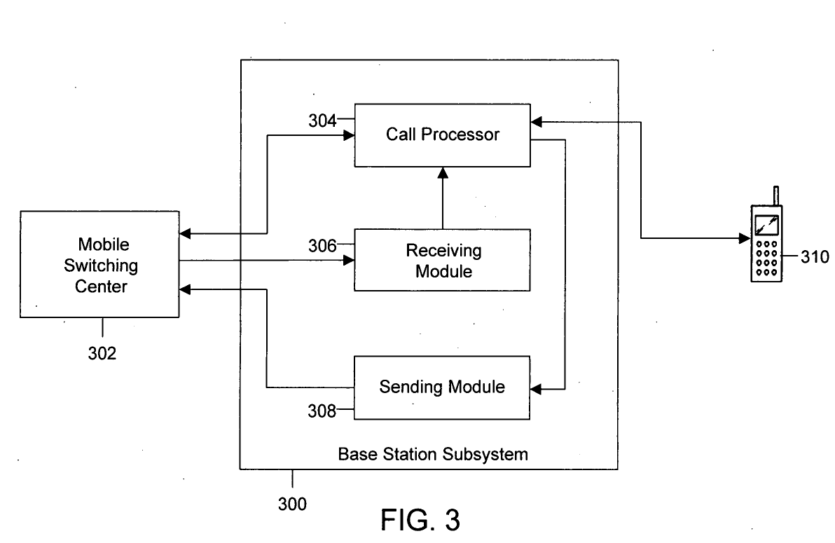

FIG. 3 is a block diagram of a base station subsystem 300. In an embodiment of the present invention, base station subsystem 300 establishes radio links with second communication device 104 when second communication device 104 is out of home network 116. For example, base station subsystem 216 has established radio links with the second communication device 104. Base station subsystem 300 includes a call processor 304, a receiving module 306 and a sending module 308. Call processor 304 sends a registration order message to a communication device. For example, call processor 304 of base station subsystem 300 sends a registration order message to a communication device 310. Further, call processor 304 receives a registration message from a communication device. For example, call processor 304 receives a registration message from communication device 310. In addition, call processor 304 updates a directly connected mobile switching center about the registration information received from a communication device. For example, call processor 304 updates mobile switching center 302 about the registration information received from communication device 310. In another embodiment, call processor 304 sends a page request to communication device 310. Receiving module 306 receives an information update message from a directly connected mobile switching center. Sending module 308 sends an update acknowledge message to a directly connected mobile switching center. For example, receiving module 306 receives information update message from mobile switching center 302 and sending module 308 sends update acknowledge message to mobile switching center 302.

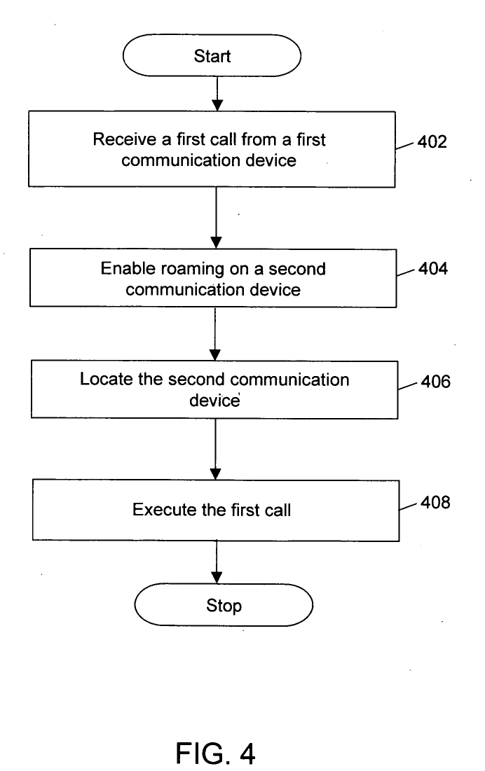

FIG. 4 is a flowchart of a method for call processing, in accordance with an embodiment of the present invention. At step 402, a first call is received by home mobile switching center 106. The first call is received from first communication device 102 to communicate with second communication device 104. First communication device 102 is in first network 114. First network 114 is the home network of first communication device 102. Second communication device 104 is in a second network 118. Second communication device 104 has connectivity only within home network 116. Home network 116 is the home network of the second communication device 104. The first call is made by using a feature code and a connection number for second communication device 104. The feature code is specific to the first call and is provided by the service provider of the first communication device 102. At step 404, roaming is enabled on second communication device 104 by home location register 112. At step 406, the location of second communication device 104 is determined. Location of second communication device 104 is determined by home mobile switching center 106. Second communication device 104 is located by determining serving mobile switching center 108. In an embodiment of the present invention, second communication device 104 is located by using network architectures, as described in FIGS. 1a and 1b.

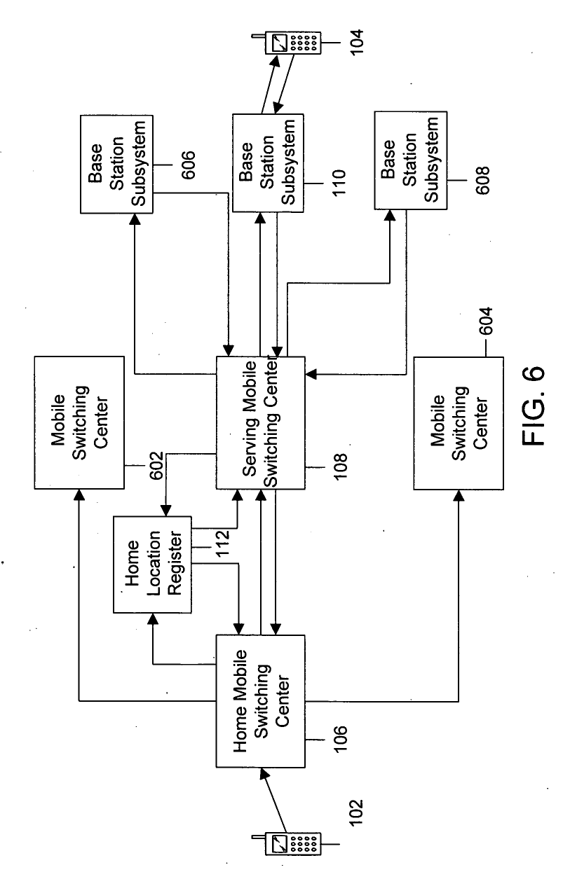

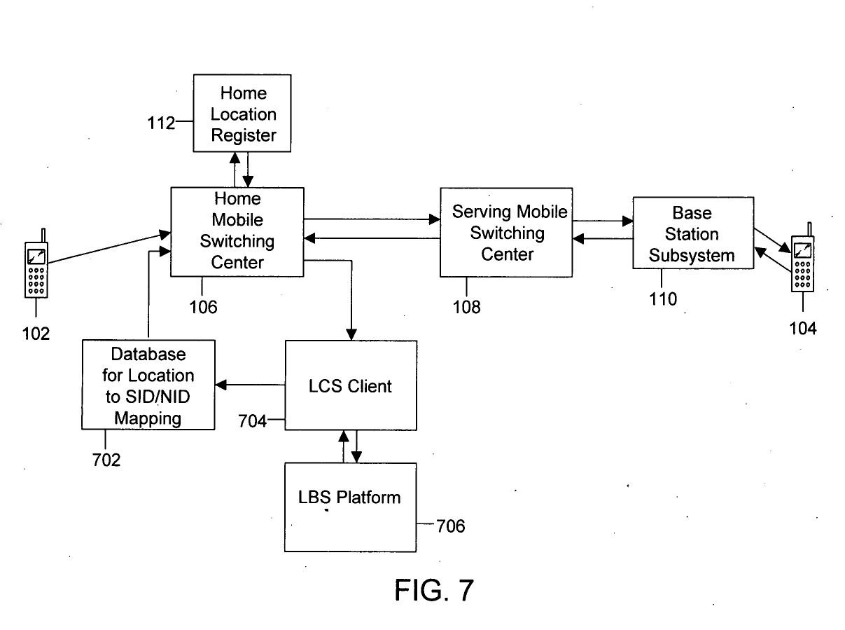

The process of determining the location of second communication device 104 is further explained in conjunction with FIG. 6. In another embodiment of the present invention, second communication device 104 is located by using location based services. The process of determining the location of second communication device 104 by using location based services is further explained in conjunction with FIG. 7. In addition, Network Detected System Selection (NDSS) is enabled through which second communication device 104 may get registered with base station subsystem 110. NDSS is enabled by base station subsystem 110. NDSS allows second communication device 104 to select a service provider in a network. In an embodiment, the selected service provider is the service provider of second communication device 104 in home network 116. In another embodiment, the selected service provider is a service provider that has an SLA with the service provider of second communication device 104 in home network 116. At step 408, the first call to second communication device 104 is executed. The first call to second communication device 104 is executed by terminating the first call on second communication device 104.

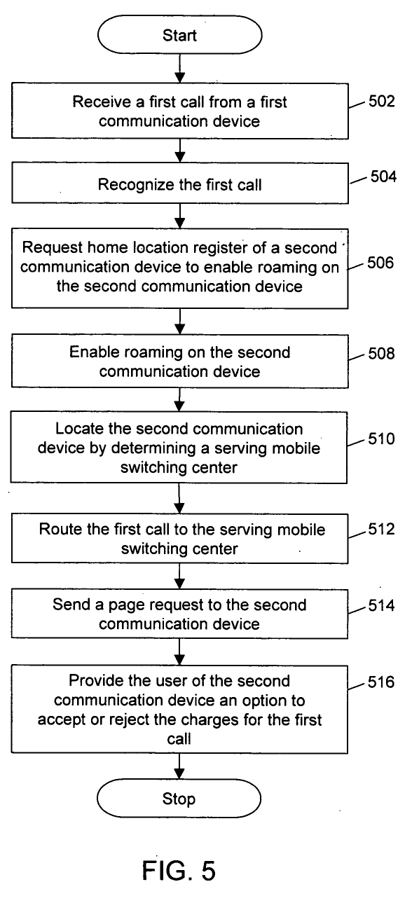

FIG. 5 is a flowchart of a method for call processing, in accordance with another embodiment of the present invention. At step 502, a first call is received by a call processing module of home mobile switching center 106. The first call is received from first communication device 102 to communicate with second communication device 104. First communication device 102 is in first network 114. First network 114 is the home network of first communication device 102. Second communication device 104 is in a second network 118. Second communication device 104 has connectivity only within home network 116. Home network 116 is the home network of the second communication device 104. The first call is made by using a feature code and a connection number for second communication device 104. The feature code is provided by the service provider of the first communication device 102 and is specific to the first call. At step 504, the first call is recognized by the call processing module of home mobile switching center 106. A requesting module of home mobile switching center 106 is informed about the first call by the call processing module. At step 506, a request for enabling roaming on second communication device 104 is made by the requesting module of home mobile switching center 106 to home location register 112 of second communication device 104.

At step 508, roaming is enabled on second communication device 104, based on the request from the requesting module of home mobile switching center 106. Roaming on second communication device 104 is enabled by home location register 112. At step 510, the location of second communication device 104 is determined. Location of second communication device 104 is determined by location determining module of home mobile switching center 106. Second communication device 104 is located by determining serving mobile switching center 108. In an embodiment of the present invention, second communication device 104 is located by using network architectures as described in FIGS. 1a and 1b. The process of determining the location of second communication device 104 is further explained in conjunction with FIG. 6.

In another embodiment of the present invention, second communication device 104 is located by using location based services. The process of determining the location of second communication device 104 by using location based services is further explained in conjunction with FIG. 7. At step 512, the first call is routed to serving mobile switching center 108. The first call is routed by the call processing module of home mobile switching center 106. In an embodiment of the present invention, the first call is routed to serving mobile switching center 108 through tandem mobile switching center 120. Tandem mobile switching center 120 is in a third network 122. A service provider in third network 122 has an SLA with the service provider of second communication device 104 in home network 116 and a service provider in second network 118. The routing of the first call to a serving mobile switching center 108 through a tandem mobile switching center 120 is further explained in conjunction with FIG. 1b. The first call is routed to base station subsystem 110 by serving mobile switching center 108. In addition, a page request is sent to base station subsystem 110 by serving mobile switching center 108. At step 514, the page request is sent to second communication device 104. The page request is sent by a call processor of base station subsystem 110.

In addition, Network Detected System Selection (NDSS) is enabled, through which, second communication device 104 may get registered with base station subsystem 110. An NDSS is enabled by base station subsystem 110. The NDSS allows second communication device 104 to select a service provider in a network. In an embodiment, the selected service provider is the service provider of second communication device 104 in home network 116. In another embodiment, the selected service provider is a service provider that has an SLA with the service provider of second communication device 104 in home network 116. The first call is executed when the page request is successfully sent to second communication device 104.

In an embodiment of the invention, the charges for a first call are billed to a communication device that makes the first call. For example, the charges for the first call made by first communication device 102 to second communication device 104 are billed to first communication device 102. At step 516, the user of second communication device 104 is given an option to accept or reject the charges for the first call. If the user of second communication device 104 accepts the charges for the first call, the first call is executed. The billing mechanism of a mobile switching center may be modified to ensure that the communication device that has made the first call is charged for the first call made to the second communication device.

In another embodiment of the present invention, the charges for a first call are billed to a communication device that receives the first call. The call processing module of the mobile switching center provides the user of a communication device that receives the first call an option to accept or reject the charges for the first call. If the user of the communication device accepts the charges for the first call, the first call is executed. For example, it is checked whether the user of second communication device 104 is accepting the charges for the first call made by first communication device 102. If communication device 104 accepts the charges for the first call, the first call is executed. The billing mechanism of a mobile switching center may be modified to ensure that the communication device that receives the first call is charged for the first call.

It will be appreciated by a person ordinarily skilled in the art that the modifications required in the billing mechanism of the mobile switching center may be hardware modifications or software modifications or a combination of both hardware and software modifications.

It will be appreciated by a person ordinarily skilled in the art that the user of the. second communication device can be given an option to accept or reject the charges for the first call by an operator.

FIG. 6 illustrates a process for locating second communication device 104 by using network architectures as described in FIGS. 1a and 1b. An information update message is sent to all the directly connected mobile switching centers, such as mobile switching center 602, serving mobile switching center 108, and mobile switching center 604 by the message exchange module of home mobile switching center 106. The information update message informs the directly connected mobile switching centers about the first call made to second communication device 104. The information update message contains information specific to second communication device 104. This information may be used as a key for identifying second communication device 104. When the directly connected mobile switching centers receive the information update message, each directly connected mobile switching center further broadcasts the information update message to all the base station subsystems directly connected to it. For example, serving mobile switching center 108 broadcasts the information update message to base station subsystems 606, 110 and 608. When a base station subsystem, which has established radio links with second communication device 104 in second network 118, receives the information update message for the first call, the base station subsystem sends an update acknowledge message to the connected mobile switching center. This mobile switching center becomes the serving mobile switching center of second communication device 104. For example, when base station subsystem 110, which has established radio links with second communication device 104, receives the information update message for the first call, base station subsystem 110 sends an update acknowledge message to serving mobile switching center 106. An information update message is sent to serving mobile switching center 108 about the first call. The information update message is sent by home mobile switching center 106 through the PSTN links. In case tandem mobile switching center 120 is present between home mobile switching center 106 and serving mobile switching center 108, the information update message is first sent to tandem mobile switching center 120, which then sends the information update message to serving mobile switching center 108. A request is sent to base station subsystem 110 to send an order for registration to second communication device 104. The request is made by serving mobile switching center 108 after receiving the information update message.

A registration order message is sent to second communication device 104 for getting registered with base station subsystem 110. The registration order message is sent by base station subsystem 110. An update acknowledge message is sent to serving mobile switching center 108. The update acknowledge message provides information that base station subsystem 110 has sent the registration order message. The update acknowledge message is sent by base station subsystem 110.

On receiving the registration order message, second communication device 104 registers with base station subsystem 110. After second communication device 104 gets registered with base station subsystem 110, a registration message is sent to base station subsystem 110. The registration message provides information about the registration of second communication device 104. The registration message is sent by second communication device 104.

Serving mobile switching center 108 is updated with the registration information received from second communication device 104 by base station subsystem 110. A registration notification message is sent to home location register 112. The registration notification message is sent by serving mobile switching center 108. The registration notification message informs home location register 112 about the current location of second communication device 104. In addition, the update acknowledge message is further sent to home mobile switching center 106 by serving mobile switching center 108. In case where tandem mobile switching center 120 is present between home mobile switching center 106 and serving mobile switching center 108, the update acknowledge message is first sent to tandem mobile switching center 120, which further sends the update acknowledge message to home mobile switching center 106. The update acknowledge message provides information to home mobile switching center 106 about the registration of second communication device 104. A LOCREQ message is sent to home location register 112 by home mobile switching center 106 on receiving the update acknowledge message. The LOCREQ message requests the location of second communication device 104. A ROUTEREQ message is sent to serving mobile switching center 108 by home location register 112 on receiving the LOCREQ message. The ROUTEREQ message requests a valid route for the delivery of the first call to second communication device 104. A temporary number is allocated for second communication device 104 by serving mobile switching center 108 on receiving the ROUTEREQ message. The temporary number is provided to home location register 112 in a ROUTEREQ return result message. The temporary number is provided by serving mobile switching center 108. The temporary number is sent to home mobile switching center 106 by home location register 112. The first call may be routed to second communication device 104, using this temporary number.

When a base station subsystem fails to detect a communication device, based on the information provided in the information update message, the base station subsystem sends an update acknowledge message with failure indication to a directly connected mobile switching center. The directly connected mobile switching center sends the update acknowledge message to the home mobile switching center with failure indication. -In addition, the directly connected mobile switching center sends a query message to the home mobile switching center. The query message requests a list of mobile switching centers from which the home mobile switching center received update acknowledge message with failure indication. The directly connected mobile switching center then broadcasts the information update message to all the directly connected mobile switching centers, except for the mobile switching centers that are in the list provided by the home mobile switching center. The steps performed by the home mobile switching center for determining the location of second communication device are followed by each directly connected mobile switching center. Once a mobile switching center receives update acknowledge message with a success indication, the mobile switching center adds the second communication device as a local subscriber and becomes the serving mobile switching center for the second communication device. The serving mobile switching center then sends a feature request message to the home mobile switching center through a tandem mobile switching center. The home mobile switching center requests the home location register of the second communication device to activate call forwarding on the home mobile switching center. A forwarding number is provided by the serving mobile switching center to which the first call can be routed.

It will be apparent to a person ordinarily skilled in the art that existing standardized interfaces used in inter mobile switching center communication (MSC) or MSC to base station subsystem (BSS) communication may be enhanced to support various messages described above.

FIG. 7 illustrates the use of location-based services for locating second communication device 104, in accordance with an embodiment of the present invention. An example of a location-based service is a Global Positioning System (GPS) assisted location based service. As illustrated in FIG. 7, a request for determining the location of second communication device 104 is made by the location determining module of home mobile switching center 106. The request is received by a Location Services (LCS) client 704. The request is sent to a Global Positioning System (GPS) assisted Location Based Services (LBS) platform 706 by LCS client 704. The position of second communication device 104 is calculated by LBS platform 706 on receiving the request. The position of the second communication device 104 is calculated in the form of geographical information such as latitude and longitude. The position of second communication device 104 is sent to LCS client 704 by LBS platform 706. The position of second communication device 104 is further sent to a database 702 by LCS client 704. The position of second communication device is mapped to a cell-sector based position such as Sector ID (SID) and Network ID (NID) pair for second communication device 104 by database 702. The cell-sector based position of second communication device 104 is sent to home mobile switching center 106 by database 702. A mobile switching center that serves the Sector ID (SID) and Network ID (NID) pair received from database 702, is identified as a serving mobile switching center. For example, serving mobile switching center 108 is identified for second communication device 104. Serving mobile switching center 108 is identified by home mobile switching center 106.

Once serving mobile switching center 108 is identified, an information update message is sent to serving mobile switching center 108 about the first call. The information update message is sent by home mobile switching center 106 through PSTN links. In case tandem mobile switching center 120 is present between home mobile switching center 106 and serving mobile switching center 108, the information update message is first sent to tandem mobile switching center 120, which further sends the information update message to serving mobile switching center 108. A request is sent to base station subsystem 110 to send an order for registration to second communication device 104. The request is made by serving mobile switching center 108 after receiving the information update message.

A registration order message is sent to second communication device 104 for registering with base station subsystem 110. The registration order message is sent by base station subsystem 110. An update acknowledge message is sent to serving mobile switching center 108. The update acknowledge message provides information that base station subsystem 110 has sent the registration order message. The update acknowledge message is sent by base station subsystem 110. The update acknowledge message is further sent to home mobile switching center 106 by serving mobile switching center 108. In the case where tandem mobile switching center 120 is present between home mobile switching center 106 and serving mobile switching center 108, the update acknowledge message is first sent to tandem mobile switching center 120, which further sends the update acknowledge message to home mobile switching center 106.

On receiving the registration order message, second communication device 104 registers with base station subsystem 110. After second communication device 104 gets registered with base station subsystem 110, a registration message is sent to base station subsystem 110. The registration message provides information about the registration of second communication device 104. The registration message is sent by second communication device 104. Serving mobile switching center 108 is updated about the registration information received from second communication device 104 by base station subsystem 110. A registration notification message is sent to home location register 112. The registration notification is sent by serving mobile switching center 108. The registration notification message informs home location register 112 about the current location of second communication device 104. In addition, the update acknowledge message is further sent to home mobile switching center 106 by serving mobile switching center 108.

In the case where tandem mobile switching center 120 is present between home mobile switching center 106 and serving mobile switching center 108, the update acknowledge message is first sent to tandem mobile switching center 120, which further sends the update acknowledge message to home mobile switching center 106. The update acknowledge message provides information to home mobile switching center 106 about the registration of second communication device 104. A LOCREQ message is sent to home location register 112 by home mobile switching center 106 on receiving the update acknowledge message. The LOCREQ message requests the location of second communication device 104. A ROUTEREQ message is sent to serving mobile switching center 108 by home location register 112 on receiving the LOCREQ message. The ROUTEREQ message requests a valid route for the delivery of the first call to second communication device 104. A temporary number is allocated for second communication device 104 by serving mobile switching center 108 on receiving the ROUTEREQ message. The temporary number is provided to home location register 112 in an ROUTEREQ return result message. The temporary number is provided by serving mobile switching center 108. The temporary number is sent to home mobile switching center 106 by home location register 112. The first call may be routed to second communication device 104, using the temporary number.

It will be apparent to a person ordinarily skilled in the art that the second communication device should be GPS assisted (device with a GPS receiver) to support the first call. Additionally, timer values for sending messages such as the LOCREQ message may require a change as call processing takes an extra step to determine the location of second communication device 104.

It will be apparent to a person ordinarily skilled in the art that the present invention is not limited to the use of above-mentioned technologies for locating a communication device. Other similar technologies such as satellite paging, whether existing or evolving, may be used for locating a communication device.

What is claimed is:

1. A method for enabling a first communication device to communicate with a second communication device, the first communication device being in a first network, the second communication device being in a second network, the second communication device having connectivity within the home network of the second communication device only, the method comprising the steps of:
a. receiving a first call from the first communication device for communicating with the second communication device;
b. enabling roaming on the second communication device, wherein the roaming is enabled on receiving the first call from the first communication device;
c. locating the second communication device; and
d. executing the first call.

2. The method according to claim 1, wherein the communication between the first communication device and the second communication device is enabled through a third network.

3. The method according to claim 1, wherein the service provider for the first communication device in the first network has a service level agreement with the service provider for the second communication device in the home network.

4. The method according to claim 1, wherein the service provider for the second communication device in the home network has a service level agreement with a service provider in the second network.

5. The method according to claim 1, wherein a service provider in the third network has a service level agreement with the service provider for the second communication device in the home network and a service provider of second network.

6. The method according to claim 1, wherein the first call is made using a feature code and a connection number of the second communication device.

7. The method according to claim 1 further comprises the step of recognizing the first call based on the feature code used for the first call.

8. The method according to claim 1 further comprises the step of requesting a home location register of the second communication device to enable roaming on the second communication device.

9. The method according to claim 1, wherein locating the second communication device comprises the step of determining the serving mobile switching center (MSC-S) of the second communication device.

10. The method according to claim 9, wherein the MSC-S is determined by using at least one message selected from a group comprising an information update message, an update acknowledge message and a query response message.

11. The method according to claim 1, wherein the second communication device is located by using a location based service.

12. The method according to claim 11, wherein the second communication device is located by using a global positioning system (GPS) assisted location based service.

13. The method according to claim 1, wherein the step of executing the first call comprises routing the first call to the serving mobile switching center (MSC-S) of the second communication device.

14. The method according to claim 1, wherein the step of executing the first call comprises sending a page request to the second communication device.

15. The method according to claim 1, wherein a user of the first communication device is billed for the first call.

16. The method according to claim 1, wherein a user of the second communication device is billed for the first call.

17. The method according to claim 1 further comprises the step of providing the user of the second communication device an option to accept or reject the charges for the first call.

18. A method for enabling a first communication device to communicate with a second communication device, the first communication device being in a first network, the second communication device being in a second network, the second communication device having connectivity within home network of the second communication device only, the method comprising the steps of:
a. receiving a first call from the first communication device for communicating with the second communication device, the first call being made by using a feature code and connection number of the second communication device;
b. enabling roaming on the second communication device after receiving the first call from the first communication device;
c. locating the second communication device; and
d. executing the first call.

19. A mobile communication network suitable for enabling a first communication device to communicate with a second communication device, the mobile communication network comprising a plurality of mobile switching centers, each mobile switching center comprising:
a. a call processing module, the call processing module processing a first call;
b. a requesting module, the requesting module requesting the home location register of the second communication device to enable roaming on the second communication device;
c. a message exchange module; and
d. a location determining module, the location determining module determining the location of the second communication device.

20. The mobile communication network according to claim 19, wherein the message exchange module sends an information update message and receives an update acknowledge message.

21. The mobile communication network according to claim 19, wherein the location determining module determines the location of the second communication device by determining the MSC-S of the second communication device.

22. The mobile communication network according to claim 19, wherein the location determining module determines the location of the second communication device using location based services.

23. The mobile communication network according to claim 22, wherein the location determining module determines the location of the second communication device using GPS assisted location based services.

24. The mobile communication network according to claim 19, further comprising a plurality of base station subsystems, each base station subsystem comprising:
a. a call processor;
b. a receiving module, the receiving module receiving the information update message; and
c. a sending module, the sending module sending the update acknowledge message.

25. The mobile communication network according to claim 24, wherein the call processor requests the second communication device to get registered with the base station subsystem.

26. The mobile communication network according to claim 24, wherein the call processor pages the second communication device.

27. The mobile communication network according to claim 19, wherein a user of the first communication device is billed for the first call.

28. The mobile communication network according to claim 19, wherein a user of the second communication device is billed for the first call.

29. The mobile communication network according to claim 28, wherein the call processing module provides the user of the second communication device an option to accept or reject the charges for the first call.
